(19) United States
(12) Patent Application Publication
(10) Pub. No.: US 2002/0092590 A1
(43) Pub. Date: Jul. 18, 2002

(54) Treaded Traction device

(76) Inventor: Donald T. Howell, Sea Tac, WA (US)

Correspondence Address: DONALD T. HOWELL, 19020 46TH AVE. SO., SEATAC, WA, 98188, US

(21) Appl. No.: 09/681,121

(22) Filed: Jan. 12, 2001

(51) Int. Cl. B60C 27/00

(52) U.S. Cl. 152/185

(57) ABSTRACT

A treaded traction cable device provided for use on a vehicle tire to increase traction in snow, ice or on other slippery or wet surfaces. It is intended for easy installation and extended use. The treaded traction cable comprises a pair of steel cable side members having first and second ends. A plurality of traversing cable cross members which secures a road gripping grade traction tire tread over the road gripping aspect of the underlying tire, also providing a plurality of extended traversing steel cable segments each with a steel ring on their ends, whereby providing connectability of the traversing steel cable cross members to the tensioning steel cable side members. On the first end of both steel cable side members a releasable connector mechanism for releasably connecting the first and second ends of each of the steel cable side members. The traversing steel cable cross members has ends and each of the ends have a steel ring attached. Each traversing steel cable cross members incorporates said treaded road gripping traction tire tread. The steel cable side members each have ends a first and second end. The first end is comprised of an adjustable leverage mechanism. The releasable connector mechanism includes a steel ring connected to the first end of each side member, a linked chain connected to said steel ring by a tempered steel releasable “S” hook or easily removable appropriate locking device, and a tempered-steel tightening lever. The second ends each comprised of a tempered steel ring used for leverage in conjunction with the previously mentioned tempered steel tightening lever. Other tensioning devices can be applied but do not change the spirit of this invention. Side cable rings used for interconnecting traversing steel cable cross members to the lateral side steel tension cable members. Lateral side traversing steel cable cross members need not be visible, that is, any type of durable covering can be applied as part of the tread mold or otherwise over the cable cross members for aesthetics. A durable ply material is bonded on the inner aspect of the device to inhibit the concern of separation of the road gripping traction tread from the traversing steel cable. Use of an embedded resistive material on the interior aspect of the said durable ply material provides added protection against slippage from the vehicle tires road gripping treads against interior of the said treaded traction device.

### CROSS REFERENCE TO RELATED APPLICATIONS

U.S. Pat. Nos. 4,111,251 4,378,040 4,457,131 4,568,394 4,615,368 4,825,923 5,624,509 6,053,227 6,085,816.

### BACKGROUND OF THE INVENTION

Certain tires are usually not suitable for use in snowy or off road conditions. The standard practice is to use chains, cable chains, change the tires, or to change the tires and wheels according to the conditions. This practice can be daunting or cumbersome for many as well as in the case of snow tires, present the added problem of off season storage, or transporting before and after installation in vehicles when done by service professionals.

The molded construction of this invention makes installation easier as well as providing safety, durability, with the possibility of an endless array of radical tread designs minus the full cost of a specialized tire for the specific condition.

### SUMMARY OF THE INVENTION

According to the invention, there is provided a removable treaded traction device for a vehicle tire comprised of a one or two sectioned connectable strip of traction tread made of road gripping grade rubber with or without studs, having placed within it during its forming as part of the mold process and reinforced therein by a durable polyester ply layer to prevent tread tear away, is a plurality aircraft grade cabling, which has secured on their ends steel rings. Steel cabling forming side members when treaded through said steel rings. On its ends a tensioning device which when connected forms a method of tightening and securing said road gripping traction tread firmly and safely to vehicle tire.

### BRIEF DESCRIPTION OF DRAWINGS

FIG. 1 is a side view of treaded traction device, according to the invention, mounted on vehicle tire.

FIG. 2 is an exploded view of a variation of the tightening/securing mechanism, also the notches and pins used for securing the seam on traction device.

FIG. 3 Is a view of the layers wherein comprises the invention.

### DETAILED DESCRIPTION

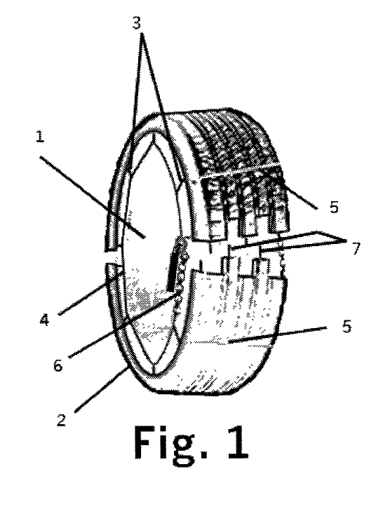

FIG. 1 reference number 1 represents existing vehicle tire, 2 generally represents the first section of the treaded road gripping rubber traction cover where the treaded traction treaded device is comprised of a first and a second section. The aircraft steel cable traversing member 3 extending from 5 the imbedded aspect of the steel cable traversing member, the extending traversing member 3 provides connectability to the side steel cable members 4 which has on its ends methods of connectability that provides tensioning continuity. One method of tensioning 6 secures the treaded traction sections firmly into one traction device.

The ends of the treaded traction sections have notches and protrusions, the protrusions have pins 7 that insert into corresponding holes that prevents the seam from opening due to centrifugal force or otherwise excessive wear and the notched aspect prevent lateral movement.

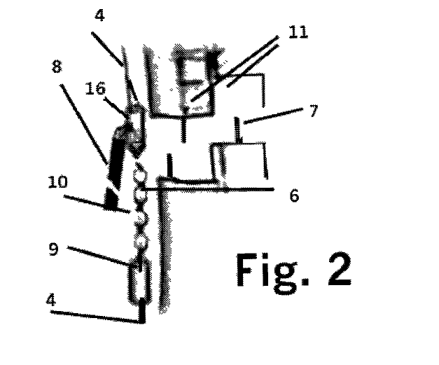

FIG. 2 shows an exploded view of the tensioning mechanism. The side tensioning steel cable 4 connects to the 9 steel ring by forming a loop on the end of the side tensioning steel cable incorporating the steel said steel ring and securing the loop with a compression type connection capable of supporting lateral forces created by vehicle movement.

A steel chain 6 with a “S” hook on one end that connects to the steel ring 9 whereby said “S” hook facilitates removing slack when tensioning traction device. The other end of said steel chain 6 connects to a tempered steel lever 8. Which is inserted through the steel ring 16 whereby when tension is applied securing of said tensioning device is complete.

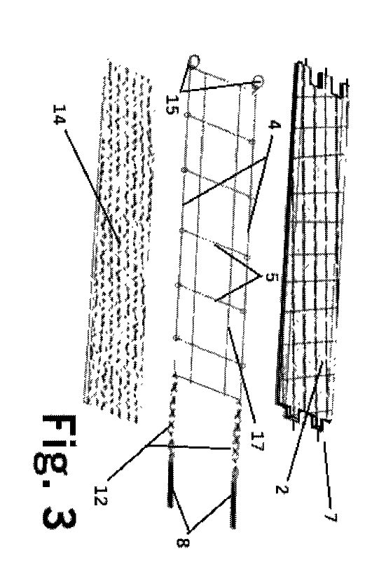

FIG. 3 shows three layers of manufacture of invention.

In the traction tread mold process the traversing steel cable 5 and the steel cable restricting lateral movement 17 are placed in the rubber and made part of the tread mold.

The durable polyester ply 14 or suitable material is bonded onto interior of the combined tread/steel cable strip creating a secure treaded traction device.

1] A removable treaded traction device for a vehicle tire comprising of four aspects 1. Road gripping, 2. Steel cable skeleton, 3. Bonding/anti-tear layer, and 4. Tightening/securing 1. The road gripping aspect includes the tread and the pin interlock. The tread is comprised of road grade rubber currently used tire manufacture; the tread is generally consistent with traction/stud design that offer the best performance for the vehicle available on the market, or new radical designs not normally available can be developed, also various colors could be applied to the rubber for a specialized market, the pins are of stainless composition and rigidly connected together then placed in each opposite notch of the tread strip during the mold process.

2. The steel cable skeleton comprises a plurality of traversing steel cable members imbedded in the tread rubber during the mold/bonding process, a plurality of stainless steel rings attach to the extended ends of the exposed traversing steel cable members to facilitate the tightening/securing aspect of the invention, the lengthwise interior steel cables provide additional bondable surface area to minimize the possibility of separation of the tread from the steel cable due to lateral forces, connecting additional steel cable, flat or round, to two or more traversing steel cable members to be included in the mold/bonding process can create additional surface.

3. The bonded anti-tear layer provides a tough layer of polyester or any tear resistant material that bonds completely with the tread rubber thereby preventing the steel cable and traction tread from separating, and also provides an interior skid/slip resistant surface that has contact with the road gripping traction surface of the vehicle tire.

4. The tightening/securing aspect comprises two side steel cable members, (one inner one outer), a tightening device comprised of a length of chain with a tempered lever on the first ends and stainless steel rings on the second ends whereby when said lever is inserted and adjustments are made, completes the tensioning/securing of said traction device, or in its entirety, a ratchet tensioning device to perform the same.
